(19) United States
(12) Patent Application Publication
(10) Pub. No.: US 2026/0222864 A1
(43) Pub. Date: Jul. 30, 2026

(54) METHOD AND DEVICE FOR REPORTING POWER DOMAIN INFORMATION, METHOD AND DEVICE FOR RECEIVING POWER DOMAIN INFORMATION, AND STORAGE MEDIUM

(71) Applicant: Beijing Xiaomi Mobile Software Co., Ltd., Beijing (CN)

(72) Inventor: Xueyuan GAO, Beijing (CN)

(21) Appl. No.: 19/143,854

(22) PCT Filed: Dec. 30, 2022
(86) PCT No.: PCT/CN2022/144258

§ 371 Date: Jun. 26, 2025

(51) Int. Cl. H04W 24/10; H04W 52/06

(52) U.S. Cl. CPC H04W 24/10; H04W 52/06

(57) ABSTRACT

A method for reporting power domain information, performed by a terminal, the method including: measuring power domain information within an uplink evaluation period, where the power domain information at least includes effective power information or effective energy information, and the effective power information or the effective energy information is configured to indicate power performance supported by the terminal within a remaining effective transmission time of the uplink evaluation period and predicted by the terminal; and reporting the power domain information to a network device.

### CROSS-REFERENCE TO RELATED APPLICATION

The present application is a U.S. National Stage of International Application No. PCT/CN2022/144258, filed on Dec. 30, 2022, the contents of all of which are incorporated herein by reference in their entirety for all purposes.

### BACKGROUND OF THE INVENTION

In a new radio (NR) technology, carrier aggregation (CA) and dual connection (DC) are supported for a terminal equipped with dual power amplifiers (PA). In these scenarios, the terminal may simultaneously transmit an uplink physical channel or reference signal on multiple carriers.

In uplink CA and DC, a maximum transmit power of the terminal over a band combination (BC) is limited to a terminal power class defined over the BC. In related art, high power UE (HPUE) is supported to better utilize an independent PA of the terminal to achieve higher transmit power.

### SUMMARY OF THE INVENTION

The present disclosure relates to the technical field of communications, and in particular to a method and device for reporting power domain information, a method and device for receiving power domain information, and a storage medium.

According to a first aspect of embodiments of the present disclosure, a method for reporting power domain information is provided. The method is performed by a terminal and includes:

measuring power domain information within an uplink evaluation period, where the power domain information at least includes effective power information or effective energy information, and the effective power information or the effective energy information is configured to indicate power performance supported by the terminal within a remaining effective transmission time of the uplink evaluation period and predicted by the terminal; and reporting the power domain information to a network device.

According to a second aspect of embodiments of the present disclosure, a method for receiving power domain information is provided. The method is performed by a network device and includes:
receiving power domain information reported by a terminal, where the power domain information at least includes effective power information or effective energy information, and the effective power information or the effective energy information is configured to indicate power performance supported by the terminal within a remaining effective transmission time of an uplink evaluation period and predicted by the terminal.

According to a third aspect of embodiments of the present disclosure, a device for reporting power domain information is provided, and includes:
a detecting module, configured to measure power domain information within an uplink evaluation period, where the power domain information at least includes effective power information or effective energy information, and the effective power information or the effective energy information is configured to indicate power performance supported by a terminal within a remaining effective transmission time of the uplink evaluation period and predicted by the terminal; and a transmitting module, configured to report the power domain information to a network device.

According to a fourth aspect of embodiments of the present disclosure, a device for receiving power domain information is provided, and includes:
a receiving module, configured to receive power domain information reported by a terminal, where the power domain information at least includes effective power information or effective energy information, and the effective power information or the effective energy information is configured to indicate power performance supported by the terminal within a remaining effective transmission time of an uplink evaluation period and predicted by the terminal.

According to a fifth aspect of embodiments of the present disclosure, a device for reporting power domain information is provided. The device includes: one or more processors; and a memory that stores processor-executable instructions; where the one or more processors are collectively configured to perform the method described in the first aspect and any of the implementations of the first aspect.

According to a sixth aspect of embodiments of the present disclosure, a device for receiving power domain information is provided. The device includes: one or more processors; and a memory that stores processor-executable instructions; where the one or more processors are collectively configured to perform the method described in the second aspect and any of the implementations of the second aspect.

According to a seventh aspect of embodiments of the present disclosure, a non-transitory computer readable storage medium is provided. The non-transitory computer readable storage medium stores instructions, and the instructions in the non-transitory computer readable storage medium, when executed by one or more processors of a terminal, cause the terminal to perform the method described in the first aspect and any of the implementations of the first aspect.

According to an eighth aspect of embodiments of the present disclosure, a non-transitory computer readable storage medium is provided. The non-transitory computer readable storage medium stores instructions, and the instructions in the non-transitory computer readable storage medium, when executed by one or more processors of a network device, cause the network device to perform the method described in the second aspect and any of the implementations of the second aspect.

### BRIEF DESCRIPTION OF DRAWINGS

Accompanying drawings, which are incorporated in and constitute a part of this specification, illustrate embodiments consistent with the present disclosure and together with the specification, serve to explain the principles of the present disclosure.

FIG. 1 is a schematic diagram of a wireless communication system according to an example.

FIG. 2 is a schematic diagram of terminal accumulated transmission power control according to an example.

FIG. 3 is a schematic diagram of power implementation according to an example.

FIG. 4 is a schematic diagram of power implementation according to an example.

FIG. 5 is a schematic diagram of power implementation according to an example.

FIG. 6 is a diagram of a PHR configuration format under a single carrier according to an example.

FIG. 7 is a diagram of a PHR configuration format under multiple carriers according to an example.

FIG. 8 is a flowchart of a method for reporting power domain information according to an example.

FIG. 9 is a flowchart of a method for receiving power domain information according to an example.

FIG. 10 is a block diagram of a device for reporting power domain information according to an example.

FIG. 11 is a block diagram of a device for receiving power domain information according to an example.

FIG. 12 is a block diagram of a device for reporting power domain information according to an example.

FIG. 13 is a block diagram of a device for reporting power domain information according to an example.

### DETAILED DESCRIPTION OF THE INVENTION

Examples will be illustrated in detail, instances of which are represented in the accompanying drawings. In a case where the following descriptions refer to the accompanying drawings, the same number in the different accompanying drawings represents the same or similar elements unless otherwise indicated. The implementations described in the following examples do not represent all implementations consistent with the present disclosure.

As described in the background, in a new radio (NR) technology, carrier aggregation (CA) and dual connection (DC) are supported for a terminal equipped with dual power amplifiers (PA). In these scenarios, the terminal may simultaneously transmit an uplink physical channel or reference signal on multiple carriers.

In uplink CA and DC, a maximum transmit power of the terminal over a band combination (BC) is limited to a terminal power class defined over the BC. In related art, high power UE (HPUE) is supported to better utilize an independent PA of the terminal to achieve higher transmit power.

However, during actual uplink transmission of the terminal, an actual transmit power at different frequency ranges is limited due to requirements of a specific absorption rate (SAR) and a maximum permissible exposure (MPE) of electromagnetic waves. Further, a transmit power adjustment based on the requirements of the SAR and the MPE may cause significant fluctuations or interruptions in the transmit power. These power limits, power adjustments, and whether the HPUE can achieve high-power transmission have a significant impact on scheduling performed by a network device.

Thus, allowing the network device to learn about power related information of the terminal and understand the corresponding behaviors of the terminal can support better scheduling decisions by the network device. How to achieve reporting of power domain information and corresponding mechanisms and signaling is a problem that needs to be solved.

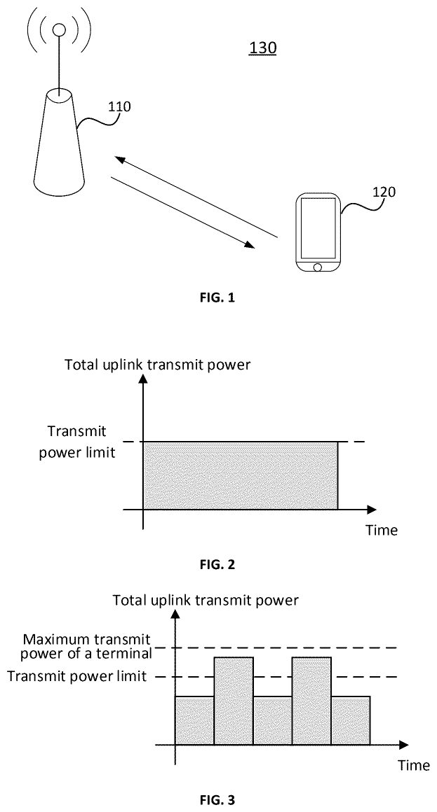

A method for reporting power domain information and a method for receiving power domain information involved in the present disclosure may be applied to a wireless communication system shown in FIG. 1. The wireless communication system 130 may include a network device 110 and a terminal 120. It may be understood that the wireless communication system 130 shown in FIG. 1 is merely a schematic illustration, and the wireless communication system 130 may further include other network devices. For example, the wireless communication system 130 may further include a core network device, a wireless relay device, a wireless backhaul device, etc., which are not shown in FIG. 1. The embodiment of the present disclosure does not limit a quantity of the network devices 110 and a quantity of the terminals 120 included in the wireless communication system 130.

It may be further understood that the wireless communication system 130 according to the embodiment of the present disclosure is a network providing a wireless communication function. The wireless communication system 130 may employ different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. A network may be divided into a 2G (generation) network, a 3G network, a 4G network or a future evolution network, such as the 5th generation wireless communication system (5G) network according to capacity, speed, delay and other factors of the different networks. The 5G network may also be called a new radio (NR) network. For convenience of description, the present disclosure sometimes refers to the wireless communication network as the network for short.

Further, the network device 110 involved in the present disclosure may also be called a radio access network device. The radio access network device may be: a base station, an evolved Node B (eNB), a femto, an access point (AP) in a wireless fidelity (WIFI) system, a wireless relay node, a wireless backhaul node, a transmission point (TP) or a transmission and receiving point (TRP), etc., may further be a gNB in an NR system, or may further be a component or part of a device that constitutes a base station. In a case of a vehicle-to-everything (V2X) communication system, the network device 110 may further be an on-board device. It is to be understood that a technology and a device form employed by the network device 110 are not limited in the embodiment of the present disclosure.

Further, the terminal 120 involved in the present disclosure may also be called a terminal device, user equipment (UE), a mobile station (MS), a mobile terminal (MT), etc., and is a device that provides at least one of voice or data connectivity to a user. For example, the terminal 120 may be a handheld device and an on-board device with a wireless connection function. Some examples of the terminal 120 are: a mobile phone, a pocket personal computer (PPC), a palm computer, a personal digital assistant (PDA), a notebook computer, a tablet computer, a wearable device, or an on-board device, etc. In addition, in a case where it is a V2X communication system, the terminal 120 may further be the on-board device. It is to be understood that a technology and a device form employed by the terminal 120 are not limited in the embodiment of the present disclosure.

In the embodiment of the present disclosure, the network device 110 and the terminal 120 may use any feasible wireless communication technology to achieve mutual data transmission. A transmission channel corresponding to data or control information transmission from the network device 110 to the terminal 120 is called a downlink (DL) channel. A transmission channel corresponding to data or control information transmission from the terminal 120 to the network device 110 is called an uplink (UL) channel. It may be understood that the network device 110 involved in the embodiment of the present disclosure may be a base station. Further, the network device 110 may also be any other possible network devices, and the terminal 120 may be any possible terminal, which are not limited in the present disclosure.

In a new radio (NR) technology, carrier aggregation (CA) and dual connection (DC) are supported for a terminal equipped with dual power amplifiers (PA), and a maximum transmit power of the terminal is affected by a power class (PC) defined by the terminal. Taking the power class defined by the terminal being PC2 as an example, a PA capability of the terminal on different bands may be different. For example, a terminal power configuration is shown in Table 1.

TABLE 1

| | Terminal | Network X carrier | Network Y carrier |
|---|---|---|---|
| | power class | power class | power class |
| Combination a | 26 dBm | 23 dBm | 23 dBm |
| Combination b | 26 dBm | 23 dBm | 26 dBm |
| Combination c | 26 dBm | 26 dBm | 23 dBm |
| Combination d | 26 dBm | 26 dBm | 26 dBm |

The X carrier and the Y carrier represent different bands. From Table 1, it can be seen that in a case where the power class of the terminal on one band is limited to be 23 decibels milliwatts (dBm) and the power class of the terminal on another band is also limited to be 23 dBm, the power class of the terminal may reach up to 26 dBm. For example, in the case of the combination b and the combination c, the power class of the terminal on one band is limited to be 23 dBm and the power class of the terminal on another band is limited to be 26 dBm, and the power class of the terminal can merely reach up to 26 dBm due to relevant protocol regulations, but in reality, a maximum transmit power of the terminal may reach 27.8 dBm. For the case of the combination d, the power class of the terminal can merely reach up to 26 dBm due to the relevant protocol regulations, but in reality, the maximum transmit power of the terminal can reach 29 dBm. That is to say, the maximum transmit power of the terminal is limited by a terminal power class specified in the protocol. In R17 regarding increasing a terminal power upper limit for CA/DC, for a band combination where one band supports the power class of up to PC3 (23 dBm) while another band supports the power class of up to PC2 (26 dBm), it can be assumed that a total power associated with the band combination is a sum of all the power classes.

In related art, new capability signaling, that is, maximum output power capability signaling, is introduced for each band combination. This capability signaling may be applied to a terminal that supports PC3 in one band and supports PC2 in another band. The band may be a band using time division duplexing (TDD) or frequency division duplexing (FDD). The terminal may use a maximum composite power from two PAs, that is 27.8 dBm, by utilizing the new maximum output power capability.

In some technologies, the key to achieving simultaneous transmission across multiple bands is for the terminal to comply with corresponding regulatory constraints when participating in uplink transmission. Regulatory constraints on total radio frequency (RF) exposure experienced by users demands the terminal to determine a safe transmit power level, namely an RF exposure level, for each band. In a case where the terminal approaches or exceeds the allowed RF exposure level, the terminal needs to recalculate a maximum allowable transmit power for each band in use, and the transmit power for uplink transmission also changes. In some cases, the terminal can set a fixed limit on its transmit power, so that the terminal never exceeds the limit of the RF exposure level.

However, as the changes in the transmit power of the terminal are transparent to the network device, that is, the network device is not aware of reasons for the changes in the transmit power of the terminal, this may affect the perception of link quality by the network device, affect link adaptation, and subsequently lead to fluctuations in uplink throughput. Therefore, making the network device to better understand these constraint conditions and impact of the constraint conditions on terminal behaviors may help the network device adopt more detailed and accurate scheduling decisions.

Currently, two types of RF exposure level limit indexes may be used according to different band combinations. One is to use a specific absorption rate (SAR) of an electromagnetic wave as a measurement index, which is mainly applicable to bands below 6 GHZ, such as a frequency range 1 (FR1). Another is to measure a power density (PD) and calculate a maximum power exposure (MPE) as a measurement index. This type of standard is mainly used in millimeter-wave bands, such as FR2. These indexes all use a time averaging method to limit the RF exposure. That is to say, an average RF exposure measured using these indexes and within a specific event window needs to be maintained below a specific threshold. It is worth noting that the protocol specifies the average radio frequency exposure, not instantaneous radio frequency exposure. There may be some exceptions in a specific region. For implementing a high-power transmission at the terminal, the property of time averaging of the constraints is a quite important aspect. This indicates that although the terminal cannot transmit at full power on all bands all the time, the terminal can transmit higher transmit power in a short period of time.

In a case where the terminal performs uplink transmission, a max UL duty cycle that the terminal can support may be determined in an uplink evaluation period according to SAR/MPE requirements in an initial stage of access, and may be reported to a network. After the establishment of a communication connection, the network device configures for the terminal a max ULdutycycle value used in subsequent transmissions according to the max UL duty cycle reported by the terminal. The terminal controls actual uplink transmission during the uplink evaluation period according to a transmission symbol proportion corresponding to the max UL duty cycle configured by the network device, and the adjustments made as a result are transparent to the network device. Further, due to relevant specifications in some countries/regions, mandatory radiation exposure requirements for the SAR/MPE may be specified on the terminal in different bands. In this case, during the uplink evaluation period, the terminal may meet the requirements of the SAR/MPE by ensuring that an actual transmission meets the UL duty cycle requirements of transmission. For example, FIG. 2 shows a schematic diagram of terminal accumulated transmission power control. A gray region shows total transmit power on a transmission symbol corresponding to an actual UL duty cycle proportion in the uplink evaluation period, and the total transmit power needs to meet an transmit power limit. This transmit power limit may be a power limit determined to meet the SAR/MPE requirements, such as 23 dBm. In FIG. 2, the terminal maintains an average transmit power on the transmission symbol corresponding to the actual UL duty cycle proportion in the uplink evaluation period to meet the transmit power limit. In fact, in some transmission time slots, the transmit power of the terminal may be lower than the transmit power limit, while in other transmission time slots, the transmit power of the terminal may be higher than the transmit power limit, as shown in a schematic diagram of power implementation in FIG. 3. From FIG. 3, it can be seen that the terminal merely needs to ensure that the average transmit power on the transmission symbol corresponding to the actual UL duty cycle proportion in the uplink evaluation period does not exceed the transmit power limit. Further, although an instantaneous transmit power in a certain time slot can exceed the transmit power limit, it still needs to meet a requirement of a maximum transmit power of the terminal, that is, the maximum transmit power of the terminal cannot be exceeded.

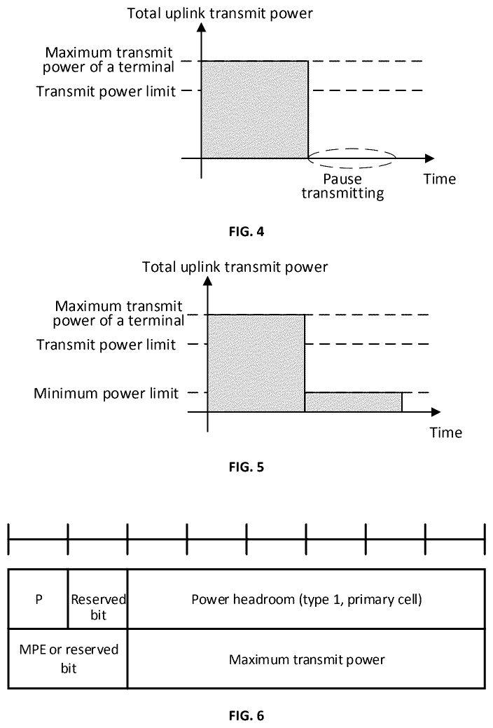

In some cases, as shown in FIG. 4, in some time slots, the terminal may use the maximum transmit power to transmit uplink data. In this case, in order to ensure that the average transmit power on the transmission symbol corresponding to the actual UL duty cycle proportion in the uplink evaluation period meets the requirements of the transmit power limit, the terminal may not be able to transmit the uplink data subsequently; and even if there is a need to transmit data during this period, the terminal also cannot continue transmitting the data. In other cases, as shown in FIG. 5, after using the maximum transmit power to transmit the uplink data in certain time slots, the terminal can merely use a minimum transmit power to transmit the uplink data in subsequent time so as to ensure that the average transmit power on the transmission symbol corresponding to the actual UL duty cycle proportion in the uplink evaluation period meets the requirements of the transmit power limit. The minimum transmit power may also be referred to as a minimum transmit power limit, which represents the minimum transmit power at which the terminal can transmit the uplink data. In a case where the transmit power is lower than the minimum transmit power limit, the terminal cannot transmit the uplink data.

According to some specifications, the terminal may use the maxUplinkDutyCycle to avoid a non-CA SAR/MPE problem for high power user equipment (HPUE). For the CA situations, this problem may be avoided through UE implementation.

According to a radio access network (RAN) 4 specification, for example, for a PC2 (26 dBm) terminal, a probability of the actual transmit power and a transmit power higher than a default transmit power (23 dBm) in a band depends on the terminal implementation, so as to ensure that the SAR/MPE requirements are met within the max UL duty cycle proportion during the uplink evaluation period. In a case where transmission does not exceed the max UL duty cycle proportion in the uplink evaluation period, a maximum of 26 dBm may be used for transmitting. However, in a case where the transmission has already exceeded the max UL duty cycle proportion in the uplink evaluation period, the transmit power class of the terminal needs to be rolled back to PC3, namely 23 dBm, during subsequent transmission. According to the RAN4 specification in R17, a maximum transmit power for inter band CA and for inter band evolution-universal terrestrial radio access network new radio dual connectivity (EN-DC) may be a sum of a maximum output power value of the aggregated band, which also depends on the terminal implementation, that is, it is ensured that an average percentage of uplink symbols transmitted in the uplink evaluation period meets the SAR/MPE requirements.

Considering that the transmit power of the terminal may vary based on the terminal implementation and these operations are transparent to the network device, the terminal may report to the network device an instantaneous transmit power for a physical uplink shared channel (PUSCH) transmission. For example, the instantaneous transmit power may be reported to the network device through a power headroom report (PHR). The PHR may include a power headroom (PH), a maximum transmit power P_{CMAX,f,c}, and a power-maximum power reduction (P-MPR). The power headroom indicates an amount of additional transmit power that the terminal can transmit with reference to a current PUSCH power class, and the P_{CMAX,f,c} indicates a maximum power that the terminal can transmit in this case.

However, the current protocol stipulates that P-MPR is merely used for the FR2 band, meaning that the MPR determined based on the MPE requirements is included in the PHR transmitted by the terminal merely in the FR2 band, while the MPR determined based on the SAR requirements is not included in the PHR transmitted by the terminal in the FR1 band.

At present, the PHR reported by the terminal includes a single-carrier-based PHR and a multiple-carrier-based PHR.

FIG. 6 shows a single-carrier PHR configuration format, which includes a P indication field, an R indication field, an MPE indication field, a PH indication field, and a P_{CMAX,f,c} indication field.

The P indication field is configured to indicate whether there is an MPE-requirements-based MPR for reporting.

The R indication field is a reserved indication field, and is configured to record corresponding newly added data when needed.

The MPE indication field is configured to indicate an MPE-requirements-based MPR value in a case where the P indication field indicates there is the MPE-requirements-based MPR for reporting.

The PH indication field is configured to indicate a transmit power headroom that the terminal can transmit when accessing a primary cell under a type 1 (PUSCH).

The P_{CMAX,f,c} indication field is configured to indicate a maximum transmit power that the terminal can transmit.

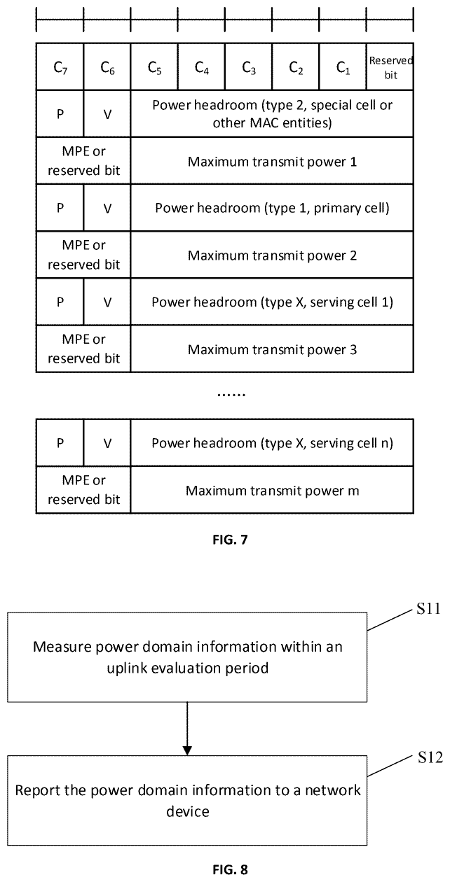

FIG. 7 shows a PHR configuration format in a case of multiple carriers. C₁ to C₇ may be used to indicate different carriers. It can be understood that a multiple-carrier PHR can be seen as a combination of a plurality of single-carrier PHRs. A type 2 may correspond to a physical uplink control channel (PUCCH), and a special cell (SpCell) may include a primary cell (PCell) and a primary secondary cell (PSCell). A serving cell may be a PCell, a secondary cell (SCell), a PSCell, a SpCell, etc.

Although the terminal can make the network device know part of a power condition of the terminal through the PHR reporting, the network device still does not know the reason of the changes in the transmit power of the terminal caused by the SAR/MPE requirements.

In the related art, due to the nature of the RF exposure varying over time, a new mechanism for the terminal to report the availability of the transmit power to the network device is introduced. In some solutions, the terminal may periodically report available energy to the network device, which may be achieved by transmitting to the network device an energy headroom report (EHR) or an energy availability report (EAR) independently or along with the PHR. For different component carriers (CCs), the terminal may perform uplink transmission using different transmit power limits. Within the UL duty cycle time window, a power accumulation reported by the PHR determines a capability of the remaining time in the window. This reporting can support the network device to learn about the impact of the SAR/MPE requirements on subsequent transmission of the terminal through a new defined manner.

In the research requirements of R18, uplink coverage is one of the bottlenecks in system performance all the time, which may affect signal quality and user experience. Operators and others all have a strong demand for uplink coverage enhancement. In the research on coverage enhancement (CE) of R18, enhancement of power domain is a topic worth exploring, which has a most direct effect on improving both coverage and spectral efficiency (SE).

In NR uplink CA/DC, the maximum transmit power defined on BC is limited by a terminal transmit power class defined on this BC. The RAN4 enhancement of R17 supports the HPUE to better utilize the independent PA of the terminal to achieve higher transmit power, mainly enhancing the PC2+PC3 configuration.

In a case where the terminal actually performs uplink transmission, the FR1 is limited by the SAR and the FR2 is limited by the MPE requirements, resulting in limitations on the actual transmit power. The adjustment of the transmit power based on the SAR/MPE requirements may also cause significant fluctuations or interruptions in the transmit power. Based on an RAN4 protocol, the terminal defines this type of implementation to be transparent to the network device. These power limits, adjustments, and whether the HPUE can achieve high-power transmission have a significant impact on scheduling performed by the network device, and also directly affect an actual effect of deploying an application in the network device by the R17 enhancement.

Thus, allowing the network device to learn about power related information of the terminal and understand the corresponding behaviors of the terminal can support better scheduling decisions by the network device. How to achieve reporting of power domain information and corresponding mechanisms and signaling is a problem that needs to be solved.

Based on this, an embodiment of the present disclosure provides a method for reporting power domain information. A terminal may measure the power domain information within an uplink evaluation period, where the power domain information at least includes effective power information or effective energy information, and the effective power information or the effective energy information is configured to indicate power performance supported by the terminal within a remaining effective transmission time of the uplink evaluation period and predicted by the terminal. Further, the terminal may report the power domain information to a network device. On this basis, the network device can understand the behavior of the terminal according to the effective power information or the effective energy information, then make better scheduling decisions, and perform scheduling more suitable for service transmission needs, thus system throughput and user coverage are improved, system efficiency is improved, and ineffective scheduling is reduced. Further, since the network device can learn about the effective power information or the effective energy information, the terminal may be scheduled based on the effective power information or the effective energy information to achieve higher power transmission and to save power for the terminal.

FIG. 8 is a flowchart of a method for reporting power domain information according to an example. As shown in FIG. 8, the method for reporting the power domain information is performed by a terminal, and includes steps S11 and S12.

In step S11, the power domain information within an uplink evaluation period is measured.

The power domain information at least includes effective power information or effective energy information, and the effective power information or the effective energy information is configured to indicate power performance supported by the terminal within a remaining effective transmission time of the uplink evaluation period and predicted by the terminal.

In step S12, the power domain information is reported to a network device.

In the embodiment of the present disclosure, the power domain information at least includes the effective power information or the effective energy information. Due to the fact that the effective power information and the effective energy information may be understood as representing the power performance in different ways, reporting of the power performance can be achieved by reporting by the terminal one of the effective power information or the effective energy information. In other words, in an implementation of the present disclosure, the power domain information includes the effective power information but does not include the effective energy information. In another implementation, the power domain information includes the effective energy information but does not include the effective power information.

In the embodiment of the present disclosure, the effective energy information is configured to indicate a remaining energy value of the terminal within the remaining effective transmission time of the uplink evaluation period, and the effective power information is configured to indicate a remaining power value of the terminal within the remaining effective transmission time of the uplink evaluation period. The energy value may be understood as an accumulated power value over a period of time.

For example, for the remaining energy value of the terminal within the remaining effective transmission time of the uplink evaluation period, a selectable reporting manner for the terminal includes the following two types:
a first reporting manner: the effective energy information includes the remaining energy value of the terminal within the remaining effective transmission time of the uplink evaluation period; and
a second reporting manner: the effective energy information includes a mapping value corresponding to the remaining energy value of the terminal within the remaining effective transmission time of the uplink evaluation period.

For ease of description, the present disclosure refers to the mapping value corresponding to the remaining energy value of the terminal within the remaining effective transmission time of the uplink evaluation period as a first mapping value.

For example, in the selectable reporting manners of the remaining energy value, the first reporting manner may be understood as direct reporting of the remaining energy value. In this case, a network device is configured to determine the power performance supported by the terminal within the remaining effective transmission time of the uplink evaluation period based directly on the remaining energy value.

The second reporting manner may be understood as indirect reporting of the remaining energy value. In this case, the network device is configured to determine the power performance supported by the terminal within the remaining effective transmission time of the uplink evaluation period based on the first mapping value. In this case, the terminal and the network device respectively store a corresponding relationship between the remaining energy value and the first mapping value. The terminal determines the first mapping value based on the corresponding relationship between the remaining energy value and the first mapping value and reports the first mapping value. The network device determines the remaining energy value corresponding to the first mapping value based on the corresponding relationship between the remaining energy value and the first mapping value, and configures for the terminal subsequent transmission decisions based on the determined remaining energy value. In an example, the network device may also not determine the remaining energy value corresponding to the first mapping value, but configure the subsequent transmission decisions for the terminal directly according to the first mapping value.

In the embodiment of the present disclosure, the corresponding relationship between the remaining energy value and the first mapping value may be configured at the terminal and the network device in various ways. For example, the corresponding relationship may be configured respectively at the terminal and the network device through pre-configuration. In an example, the network device may determine the corresponding relationship between the remaining energy value and the first mapping value, and further configure the corresponding relationship between the remaining energy value and the first mapping value on the terminal. Alternatively, the terminal may determine the corresponding relationship between the remaining energy value and the first mapping value, and further configure, on the network device, the corresponding relationship between the remaining energy value and the first mapping value.

In an implementation of the present disclosure, the effective power information may include remaining power value information of the terminal within the remaining effective transmission time of the uplink evaluation period.

For the reporting of the remaining power value information, a selectable reporting manner includes at least one of the following:
a first reporting manner: the remaining power value;
a second reporting manner: power class information;
value; or a third reporting manner: a mapping value corresponding to the remaining power
a fourth reporting manner: a differential power value between the remaining power value and a maximum transmit power reported in a power headroom report reported last time.

For ease of description, the present disclosure refers to the mapping value corresponding to the remaining power value of the terminal within the remaining effective transmission time of the uplink evaluation period as a second mapping value.

In the embodiment, for the second reporting manner of the remaining power value information, the power class information may be, for example, a power class or a power class combination configured for the terminal. In a case where the terminal reports the power class information, the network device may learn about the remaining power value of the terminal within the remaining effective transmission time of the uplink evaluation period through a configuration table.

The configuration table is shown in Table 2.

TABLE 2

| Code | | Power class | |
|---|---|---|---|
| point | Power class | combination | Power (dBm) |
| 0 | PC3 | | 23.0 |
| 1 | PC2 | | 26.0 |
| 2 | PC1.5 | | 29.0 |
| 3 | PC1.x | PC2 + PC3 | 27.8 |
| 4 | PC1.y | PC2 + PC5 | 27.0 |
| 5 | PC1.5 | PC2 + PC2 | 29.0 |
| 6 | PC2.5 | PC3 + PC5 | 24.8 |
| 7 | PC1.z | PC1.5 + PC3 | 30.0 |
| 8 | PC1.w | PC1.5 + PC5 | 29.5 |
| 9 | PC1.v | PC1.5 + PC2 | 30.8 |
| 10 | PC0.x | PC1.5 + PC1.5 | 32.0 |
| . . . | | | . . . |

For example, it can be seen from Table 2 that the configuration table shows theoretical power values respectively corresponding to different power classes or power class combinations. The network device determines the corresponding power value in the configuration table based on the power class or the power class combination reported by the terminal. For example, taking an indication of code point 3 in the configuration table as an example, in a case where the terminal reports a power class of PC1.x or reports a power class combination of PC2+PC3, the network device may correspondingly find the theoretical power value of 27.8 dBm through the configuration table. Furthermore, the network device may infer the remaining power value of the terminal within the remaining effective transmission time of the uplink evaluation period based on the found theoretical power value.

For example, for the third reporting manner of the remaining power value information, the remaining power value information may be the second mapping value corresponding to the remaining power value. In other words, the third reporting manner of the remaining power value information may be understood as indirect reporting of the remaining energy value. In this case, the network device is configured to determine the power performance supported by the terminal within the remaining effective transmission time of the uplink evaluation period based on the second mapping value. In this case, the terminal and the network device respectively store a corresponding relationship between the remaining power value and the second mapping value. The terminal determines the second mapping value based on the corresponding relationship between the remaining power value and the second mapping value and reports the second mapping value. The network device determines the remaining power value corresponding to the second mapping value based on the corresponding relationship between the remaining power value and the second mapping value, and configures subsequent transmission decisions for the terminal based on the determined remaining power value. In an example, the network device may also not determine the remaining power value corresponding to the second mapping value, but configure the subsequent transmission decisions for the terminal directly according to the second mapping value.

In the embodiment of the present disclosure, the corresponding relationship between the remaining power value and the second mapping value may be configured at the terminal and the network device in various ways. For example, the corresponding relationship may be configured respectively at the terminal and the network device through pre-configuration. In an example, it is also possible for the network device to determine the corresponding relationship between the remaining power value and the second mapping value, and further configure, at the terminal, the corresponding relationship between the remaining power value and the second mapping value. Alternatively, it is also possible for the terminal to determine the corresponding relationship between the remaining power value and the second mapping value, and further configure, at the network device, the corresponding relationship between the remaining power value and the second mapping value.

The mapping relationship between the remaining power value and the second mapping value may be, for example, configured in at least one of the following manners:
manner 1: configured based on a maximum power class (Pcmax) table; or
manner 2: configured based on a pre-defined mapping table of an actual transmit power.

In addition, in another implementation of the present disclosure, the effective power information may further include a number of symbols corresponding to the remaining energy value of the terminal within the remaining effective transmission time of the uplink evaluation period. For example, the effective power information may be the number of symbols corresponding to the remaining energy value of the terminal within the remaining effective transmission time of the uplink evaluation period. For another example, the effective power information may be proportion information of the number of symbols corresponding to the remaining energy value of the terminal within the remaining effective transmission time of the uplink evaluation period in an entire time window of the uplink evaluation period.

In the embodiment of the present disclosure, the proportion information may include, for example, a proportion range occupied by the number of symbols in the entire time window of the uplink evaluation period.

In an example, the terminal stores a corresponding relationship between a proportion range and a mapping value. For ease of description, the present disclosure refers to the mapping value corresponding to the proportion range as a third mapping value. Correspondingly, the network device also stores a corresponding relationship between the proportion range and the third mapping value. In an implementation, the terminal may determine the third mapping value based on the corresponding relationship between the proportion range and the third mapping value and reports the third mapping value. The network device determines the proportion range corresponding to the third mapping value based on the corresponding relationship between the proportion range and the third mapping value, and configures subsequent transmission decisions for the terminal based on the determined proportion range. In an example, the network device may also not determine the proportion range corresponding to the third mapping value, but configure the subsequent transmission decisions for the terminal directly according to the third mapping value.

In the embodiment of the present disclosure, the corresponding relationship between the proportion range and the third mapping value may be configured at the terminal and the network device in various ways. For example, the corresponding relationship may be configured respectively at the terminal and the network device through pre-configuration. In an example, it is also possible for the network device to determine the corresponding relationship between the proportion range and the third mapping value, and further configure, at the terminal, the corresponding relationship between the proportion range and the third mapping value. Alternatively, it is also possible for the terminal to determine the corresponding relationship between the proportion range and the third mapping value, and further configure, at the network device, the corresponding relationship between the proportion range and the third mapping value.

Correspondingly, the proportion information may include, for example, the third mapping value corresponding to the proportion range occupied by the number of symbols in the entire time window of the uplink evaluation period.

In another implementation of the present disclosure, the effective power information may further include transmission rate class information supported by the terminal within the remaining effective transmission time of the uplink evaluation period. The transmission rate class information may be understood as indicating a magnitude of the transmission rate supported by the terminal within the remaining effective transmission time of the uplink evaluation period, which for example, can be represented by at least one of the following manners:
manner 1: a service rate class;
manner 2: a highest modulation and coding scheme (MCS) class; or
manner 3: a maximum bandwidth class.

According to the method provided by the embodiment of the present disclosure, the transmission rate class supported by the terminal within the remaining effective transmission time of the uplink evaluation period is represented through at least one of the service rate class, the highest MCS class, or the maximum bandwidth class, so that the network device learns about the power performance supported subsequently by the terminal based on the transmission rate class, and adjust the transmission of the terminal accordingly. This method can ensure that the terminal performs transmission with the possibly highest transmission efficiency, so as to reduce a power consumption cost of the terminal.

In the embodiment of the present disclosure, in a case of predicting occurrence of transmission interruption of the terminal within the remaining effective transmission time of the uplink evaluation period, the effective power information or the effective energy information may be an information value indicating the transmission interruption. The information value indicating the transmission interruption may be, for example, a special value among selectable information values, such as a 0 value, or its mapping value.

In an example, in a case where occurrence of the transmission interruption of the terminal within the remaining effective transmission time of the uplink evaluation period is predicted and the power domain information includes the effective power information, the effective power information may be an information value indicating the transmission interruption.

In another example, in a case where occurrence of the transmission interruption of the terminal within the remaining effective transmission time of the uplink evaluation period is predicted and the power domain information includes the effective energy information, the effective energy information may be an information value indicating the transmission interruption.

As a feasible implementation, the effective power information or the effective energy information is included in at least one of power headroom report signaling, medium access control control element (MAC-CE) signaling, uplink control information (UCI) signaling, or radio resource control (RRC) signaling.

For example, the terminal may measure the power domain information within the uplink evaluation period in at least one of the following manners:
manner 1: measuring power domain information of each carrier within the uplink evaluation period respectively;
manner 2: measuring power domain information of a specified carrier within the uplink evaluation period; or
manner 3: measuring power domain information of the terminal within the uplink evaluation period.

The specified carrier may be understood as a carrier determined based on a specific trigger reporting condition. For example, the specified carrier may be a carrier whose power class has changed.

For example, the terminal may report the power domain information to the network device in at least one of the following manners:
manner 1: reporting the power domain information of each carrier within the uplink evaluation period to the network device respectively;
manner 2: reporting the power domain information of the specified carrier within the uplink evaluation period to the network device; or
manner 3: reporting the power domain information of the terminal within the uplink evaluation period to the network device.

On this basis, the terminal may freely combine the measurement manners of the power domain information and the reporting manners of the power domain information based on actual needs.

As a feasible implementation, the terminal may measure the power domain information of each carrier within the uplink evaluation period respectively, and report the power domain information of each carrier within the uplink evaluation period to the network device respectively.

As another feasible implementation, the terminal may measure the power domain information of the specified carrier within the uplink evaluation period, and report the power domain information of the specified carrier within the uplink evaluation period to the network device.

As another feasible implementation, the terminal may measure the power domain information of the terminal within the uplink evaluation period, and report the power domain information of the terminal within the uplink evaluation period to the network device.

As another feasible implementation, the terminal may measure the power domain information of each carrier within the uplink evaluation period respectively, and report the power domain information of the specified carrier within the uplink evaluation period to the network device.

Based on the same concept, the present disclosure further provides a method for receiving power domain information performed by a network device, for interacting with a terminal involved in any of the above-mentioned embodiments to complete the reception of the power domain information. If there is any ambiguity in the following embodiments, reference can be made to any of the above-mentioned embodiments. Similarly, if there is any ambiguity in the above-mentioned embodiments, reference can also be made to any of the following embodiments.

FIG. 9 is a flowchart of a method for receiving power domain information according to an example. As shown in FIG. 9, the method for receiving the power domain information is performed by a network device, and includes step S21.

In step S21, the power domain information reported by a terminal is received.

The power domain information is obtained based on measurement taken by the terminal within an uplink evaluation period. The power domain information at least includes effective power information or effective energy information. The effective power information or the effective energy information is configured to indicate power performance supported by the terminal within a remaining effective transmission time of the uplink evaluation period and predicted by the terminal.

According to the method provided by the embodiment of the present disclosure, in a case where the network device receives the power domain information, the network device can understand the behavior of the terminal according to the effective power information or the effective energy information, then make better scheduling decisions, and perform scheduling more suitable for service transmission needs, thus system throughput and user coverage are improved, system efficiency is improved, and ineffective scheduling is reduced. Moreover, since the network device can learn about the effective power information or the effective energy information, the terminal may be scheduled based on the effective power information or the effective energy information to achieve higher power transmission and to save power for the terminal.

In the embodiment of the present disclosure, the power domain information at least includes the effective power information or the effective energy information. Due to the fact that the effective power information and the effective energy information may be understood as indicating the power performance in different ways, reporting of the power performance can be achieved by reporting by the terminal one of the effective power information or the effective energy information. In other words, in an implementation of the present disclosure, the power domain information includes the effective power information but does not include the effective energy information. In another implementation, the power domain information includes the effective energy information but does not include the effective power information.

In the embodiment of the present disclosure, the effective energy information is configured to indicate a remaining energy value of the terminal within the remaining effective transmission time of the uplink evaluation period. For the remaining energy value of the terminal within the remaining effective transmission time of the uplink evaluation period, a selectable reporting manner for the terminal includes the following two types:
a first reporting manner: the effective energy information includes the remaining energy value of the terminal within the remaining effective transmission time of the uplink evaluation period; and
a second reporting manner: the effective energy information includes a mapping value corresponding to the remaining energy value of the terminal within the remaining effective transmission time of the uplink evaluation period.

For ease of description, the present disclosure refers to the mapping value corresponding to the remaining energy value of the terminal within the remaining effective transmission time of the uplink evaluation period as a first mapping value.

For example, in the selectable reporting manners of the remaining energy value, the first reporting manner may be understood as direct reporting of the remaining energy value. In this case, the network device is configured to determine the power performance supported by the terminal within the remaining effective transmission time of the uplink evaluation period based directly on the remaining energy value.

The second reporting manner may be understood as indirect reporting of the remaining energy value. In this case, the network device is configured to determine the power performance supported by the terminal within the remaining effective transmission time of the uplink evaluation period based on the first mapping value. In this case, the terminal and the network device respectively store a corresponding relationship between the remaining energy value and the first mapping value. The terminal determines the first mapping value based on the corresponding relationship between the remaining energy value and the first mapping value and reports the first mapping value. The network device determines the remaining energy value corresponding to the first mapping value based on the corresponding relationship between the remaining energy value and the first mapping value, and configures subsequent transmission decisions for the terminal based on the determined remaining energy value. In an example, the network device may also not determine the remaining energy value corresponding to the first mapping value, but configure the subsequent transmission decisions for the terminal directly according to the first mapping value.

In the embodiment of the present disclosure, the corresponding relationship between the remaining energy value and the first mapping value may be configured at the terminal and the network device in various ways. For example, the corresponding relationship may be configured respectively at the terminal and the network device through pre-configuration. In an example, it is also possible for the network device to determine the corresponding relationship between the remaining energy value and the first mapping value, and further configure, at the terminal, the corresponding relationship between the remaining energy value and the first mapping value. Alternatively, it is also possible for the terminal to determine the corresponding relationship between the remaining energy value and the first mapping value, and further configure, at the network device, the corresponding relationship between the remaining energy value and the first mapping value.

In an implementation of the present disclosure, the effective power information may include remaining power value information of the terminal within the remaining effective transmission time of the uplink evaluation period.

For the reporting of the remaining power value information, a selectable reporting manner includes at least one of the following:
a first reporting manner: the remaining power value;
a second reporting manner: power class information;
a third reporting manner: a mapping value corresponding to the remaining power value; or
a fourth reporting manner: a differential power value between the remaining power value and a maximum transmit power reported in a power headroom report reported last time.

For example, for the third reporting manner of the remaining power value information, the remaining power value information may be a second mapping value corresponding to the remaining power value. In other words, the third reporting manner of the remaining power value information may be understood as indirect reporting of the remaining energy value. In this case, the network device is configured to determine the power performance supported by the terminal within the remaining effective transmission time of the uplink evaluation period based on the second mapping value. In this case, the terminal and the network device respectively store a corresponding relationship between the remaining power value and the second mapping value. The terminal determines the second mapping value based on the corresponding relationship between the remaining power value and the second mapping value and reports the second mapping value. The network device determines the remaining power value corresponding to the second mapping value based on the corresponding relationship between the remaining power value and the second mapping value, and configures subsequent transmission decisions for the terminal based on the determined remaining power value. In an example, the network device may also not determine the remaining power value corresponding to the second mapping value, but configure the subsequent transmission decisions for the terminal directly according to the second mapping value.

In the embodiment of the present disclosure, the corresponding relationship between the remaining power value and the second mapping value may be configured at the terminal and the network device in various ways. For example, the corresponding relationship may be configured respectively at the terminal and the network device through pre-configuration. In an example, it is also possible for the network device to determine the corresponding relationship between the remaining power value and the second mapping value, and further configure, at the terminal, the corresponding relationship between the remaining power value and the second mapping value. Alternatively, it is also possible for the terminal to determine the corresponding relationship between the remaining power value and the second mapping value, and further configure, at the network device, the corresponding relationship between the remaining power value and the second mapping value.

The mapping relationship between the remaining power value and the second mapping value may be, for example, configured in at least one of the following manners:
manner 1: configured based on a maximum power class (Pcmax) table; or
manner 2: configured based on a pre-defined mapping table of an actual transmit power.

In addition, in another implementation of the present disclosure, the effective power information may further include a number of symbols corresponding to the remaining energy value of the terminal within the remaining effective transmission time of the uplink evaluation period. For example, the effective power information may be the number of symbols corresponding to the remaining energy value of the terminal within the remaining effective transmission time of the uplink evaluation period. For another example, the effective power information may be proportion information of the number of symbols corresponding to the remaining energy value of the terminal within the remaining effective transmission time of the uplink evaluation period in an entire time window of the uplink evaluation period.

In the embodiment of the present disclosure, the proportion information may include, for example, a proportion range occupied by the number of symbols in the entire time window of the uplink evaluation period.

In an example, the network device stores a corresponding relationship between a proportion range and a mapping value. For ease of description, the present disclosure refers to the mapping value corresponding to the proportion range as a third mapping value. Correspondingly, the terminal also stores a corresponding relationship between the proportion range and the third mapping value. In an implementation, the terminal may determine the third mapping value based on the corresponding relationship between the proportion range and the third mapping value and reports the third mapping value. The network device determines the proportion range corresponding to the third mapping value based on the corresponding relationship between the proportion range and the third mapping value, and configures subsequent transmission decisions for the terminal based on the determined proportion range. In an example, the network device may also not determine the proportion range corresponding to the third mapping value, but configure the subsequent transmission decisions for the terminal directly according to the third mapping value.

In the embodiment of the present disclosure, the corresponding relationship between the proportion range and the third mapping value may be configured at the terminal and the network device in various ways. For example, the corresponding relationship may be configured respectively at the terminal and the network device through pre-configuration. In an example, it is also possible for the network device to determine the corresponding relationship between the proportion range and the third mapping value, and further configure, at the terminal, the corresponding relationship between the proportion range and the third mapping value. Alternatively, it is also possible for the terminal to determine the corresponding relationship between the proportion range and the third mapping value, and further configure, at the network device, the corresponding relationship between the proportion range and the third mapping value.

Correspondingly, the proportion information may include, for example, the third mapping value corresponding to the proportion range occupied by the number of symbols in the entire time window of the uplink evaluation period.

In another implementation of the present disclosure, the effective power information may further include transmission rate class information supported by the terminal within the remaining effective transmission time of the uplink evaluation period. The transmission rate class information may be understood as indicating a magnitude of the transmission rate supported by the terminal within the remaining effective transmission time of the uplink evaluation period, which for example, can be represented by at least one of the following manners:
manner 1: a service rate class;
manner 2: a highest modulation and coding scheme (MCS) class; or
manner 3: a maximum bandwidth class.

According to the method provided by the embodiment of the present disclosure, the transmission rate class supported by the terminal within the remaining effective transmission time of the uplink evaluation period is represented through at least one of the service rate class, the highest MCS class, or the maximum bandwidth class, so that the network device learns about the power performance supported subsequently by the terminal based on the transmission rate class, and adjust the transmission of the terminal accordingly. This method can ensure that the terminal performs transmission with the possibly highest transmission efficiency, so as to reduce a power consumption cost of the terminal.

In the embodiment of the present disclosure, in a case of predicting occurrence of a transmission interruption of the terminal within the remaining effective transmission time of the uplink evaluation period, the effective power information or the effective energy information may be an information value indicating the transmission interruption. The information value indicating the transmission interruption may be, for example, a special value among selectable information values, such as a 0 value, or its mapping value.

In an example, in a case where the occurrence of the transmission interruption of the terminal within the remaining effective transmission time of the uplink evaluation period is predicted and the power domain information includes the effective power information, the effective power information may be an information value indicating the transmission interruption.

In another example, in a case where the occurrence of the transmission interruption of the terminal within the remaining effective transmission time of the uplink evaluation period is predicted and the power domain information includes the effective energy information, the effective energy information may be an information value indicating the transmission interruption.

As a feasible implementation, the effective power information or the effective energy information is included in at least one of power headroom report signaling, medium access control control element (MAC-CE) signaling, uplink control information (UCI) signaling, or radio resource control (RRC) signaling.

For example, the power domain information received by the network device may be power domain information, reported respectively by the terminal, of each carrier within the uplink evaluation period. For another example, the power domain information received by the network device may further be power domain information, reported by the terminal, of a specified carrier within the uplink evaluation period. For another example, the power domain information received by the network device may also be power domain information, reported by the terminal, of the terminal within the uplink evaluation period.

It is to be noted that those skilled in the art can understand that the various implementations/embodiments of the present disclosure can be used in conjunction with the embodiments of the present disclosure or independently. Whether to be used alone or together with the embodiments of the present disclosure, its implementation principle is similar. In the embodiment of the present disclosure, part of the embodiments is illustrated through the implementation used together. Those skilled in the art can understand that such examples do not limit the embodiments of the present disclosure.

Based on the same concept, an embodiment of the present disclosure further provides a device for reporting power domain information.

It may be understood that, in order to implement the functions of the present disclosure, the device for reporting the power domain information provided by the embodiment of the present disclosure includes at least one of corresponding hardware structures or software modules for executing all the functions. Combined with units and algorithm steps of each example disclosed in the embodiment of the present disclosure, the embodiment of the present disclosure can be implemented in a form of hardware or a combination of hardware and computer software. Whether a certain function is executed in a mode of hardware or a mode of the hardware driven by the computer software depends on an application and design constraint conditions of the technical solution. Those skilled in the art may use different methods to implement the described functions for each specific application, but such implementation is not to be regarded as beyond the scope of the technical solution of the embodiment of the present disclosure.

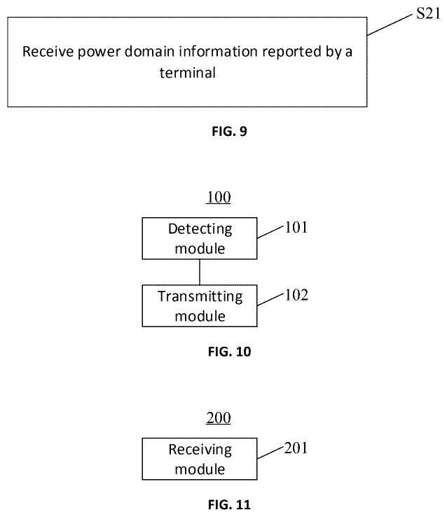

FIG. 10 is a block diagram of a device for reporting power domain information according to an example. Referring to FIG. 10, the device 100 includes a detecting module 101 and a transmitting module 102.

The detecting module 101 is configured to measure power domain information within an uplink evaluation period, where the power domain information at least includes effective power information or effective energy information, and the effective power information or the effective energy information is configured to indicate power performance supported by a terminal within a remaining effective transmission time of the uplink evaluation period and predicted by the terminal. The transmitting module 102 is configured to report the power domain information to a network device.

In an implementation, the effective energy information includes a remaining energy value of the terminal within the remaining effective transmission time of the uplink evaluation period, or a first mapping value corresponding to the remaining energy value.

In an implementation, the effective power information includes remaining power value information of the terminal within the remaining effective transmission time of the uplink evaluation period.

In an implementation, the remaining power value information includes at least one of the following: a remaining power value; power class information; a second mapping value corresponding to the remaining power value; or a differential power value between the remaining power value and a maximum transmit power reported in a power headroom report (PHR) reported last time.

In an implementation, the second mapping value corresponding to the remaining power value is configured in at least one of the following manners: configured based on a maximum power class (Pcmax) table; or configured based on a pre-defined mapping table of an actual transmit power.

In an implementation, the effective power information includes a number of symbols corresponding to a remaining energy value of the terminal within the remaining effective transmission time of the uplink evaluation period, or proportion information of the number of symbols in an entire time window of the uplink evaluation period.

In an implementation, the proportion information includes a proportion range occupied by the number of symbols in the entire time window of the uplink evaluation period.

In an implementation, the terminal stores a corresponding relationship between a proportion range and a third mapping value. The proportion information includes the third mapping value corresponding to the proportion range occupied by the number of symbols in the entire time window of the uplink evaluation period.

In an implementation, the effective power information includes transmission rate class information supported by the terminal within the remaining effective transmission time of the uplink evaluation period.

In an implementation, the transmission rate class information includes at least one of the following: a service rate class; a highest modulation and coding scheme (MCS) class; or a maximum bandwidth class.

In an implementation, in response to predicting occurrence of a transmission interruption of the terminal within the remaining effective transmission time of the uplink evaluation period, the effective power information or the effective energy information includes an information value indicating the transmission interruption.

In an implementation, the effective power information or the effective energy information is included in at least one of the following signaling: a power headroom report (PHR); a medium access control control element (MAC-CE); uplink control information (UCI); or radio resource control (RRC).

In an implementation, the detecting module 101 measures the power domain information within the uplink evaluation period in at least one of the following manners: measuring power domain information of each carrier within the uplink evaluation period respectively; measuring power domain information of a specified carrier within the uplink evaluation period; or measuring power domain information of the terminal within the uplink evaluation period.

In an implementation, the transmitting module 102 reports the power domain information to the network device in at least one of the following manners: reporting the power domain information of each carrier within the uplink evaluation period to the network device respectively; reporting the power domain information of the specified carrier within the uplink evaluation period to the network device; or reporting the power domain information of the terminal within the uplink evaluation period to the network device.

FIG. 11 is a block diagram of a device for receiving power domain information according to an example. Referring to FIG. 11, the device 200 includes a receiving module 201.

The receiving module 201 is configured to receive the power domain information reported by a terminal. The power domain information at least includes effective power information or effective energy information, and the effective power information or the effective energy information is configured to indicate power performance supported by the terminal within a remaining effective transmission time of the uplink evaluation period and predicted by the terminal.

In an implementation, the effective energy information includes a remaining energy value of the terminal within the remaining effective transmission time of the uplink evaluation period, or a first mapping value corresponding to the remaining energy value.

In an implementation, the effective power information includes remaining power value information of the terminal within the remaining effective transmission time of the uplink evaluation period.

In an implementation, the remaining power value information includes at least one of the following: a remaining power value; power class information; a second mapping value corresponding to the remaining power value; or a differential power value between the remaining power value and a maximum transmit power reported in a power headroom report (PHR) reported last time.

In an implementation, the second mapping value corresponding to the remaining power value is configured in at least one of the following manners: configured based on a maximum power class (Pcmax) table; or configured based on a pre-defined mapping table of an actual transmit power.

In an implementation, the effective power information includes a number of symbols corresponding to a remaining energy value of the terminal within the remaining effective transmission time of the uplink evaluation period, or proportion information of the number of symbols in an entire time window of the uplink evaluation period.

In an implementation, the proportion information includes a proportion range occupied by the number of symbols in the entire time window of the uplink evaluation period.

In an implementation, the network device stores a corresponding relationship between a proportion range and a third mapping value. The proportion information includes the third mapping value corresponding to the proportion range occupied by the number of symbols in the entire time window of the uplink evaluation period.

In an implementation, the effective power information includes transmission rate class information supported by the terminal within the remaining effective transmission time of the uplink evaluation period.

In an implementation, the transmission rate class information includes at least one of the following: a service rate class; a highest modulation and coding scheme (MCS) class; or a maximum bandwidth class.

In an implementation, the effective power information or the effective energy information includes an information value indicating the transmission interruption.

In an implementation, the effective power information or the effective energy information is included in at least one of the following signaling: a power headroom report (PHR); a medium access control control element (MAC-CE); uplink control information (UCI); or radio resource control (RRC).

In an implementation, the receiving module 201 receives the power domain information reported by the terminal in at least one of the following manners: receiving power domain information, reported by the terminal respectively, of each carrier within the uplink evaluation period; receiving power domain information, reported by the terminal, of a specified carrier within the uplink evaluation period; or receiving power domain information, reported by the terminal, of the terminal within the uplink evaluation period.

As for the device in the embodiments, the manners for executing operations by each module have be described in the embodiments related to the method in detail, which is not illustrated in detail here.

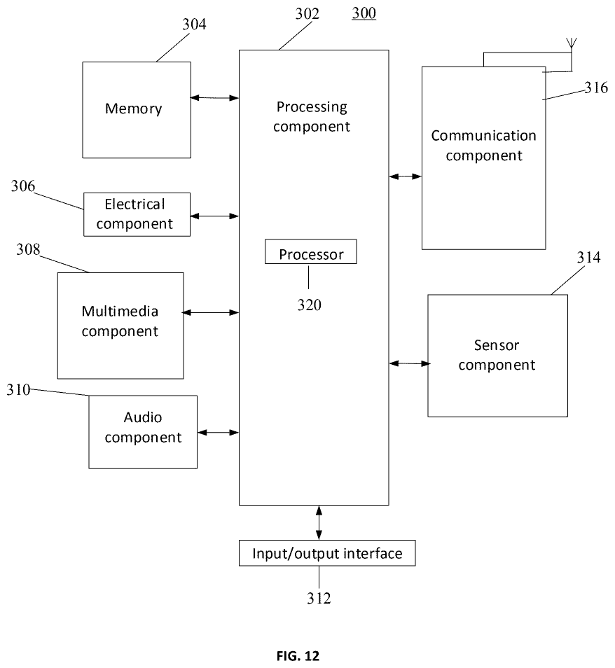

FIG. 12 is a block diagram of a device 300 for reporting power domain information according to an example. For example, the device 300 may be a mobile telephone, a computer, a digital broadcast terminal, a message transceiving device, a game console, a tablet device, a medical device, a fitness device, a personal digital assistant, and the like.

Referring to FIG. 12, the device 300 may include one or more of the following components: a processing component 302, a memory 304, an electrical component 306, a multimedia component 308, an audio component 310, an input/output (I/O) interface 312, a sensor component 314, and a communication component 316.

The processing component 302 usually controls an overall operation of the device 300, such as operations associated with displaying, telephone calling, data communication, a camera operation and a record operation. The processing component 302 may include one or more processors 320 to execute instructions, so as to complete all or part of steps of the method. In addition, the processing component 302 may include one or more modules, so as to facilitate interaction between the processing component 302 and other components. For example, the processing component 302 may include a multimedia module (not shown), so as to facilitate interaction between the multimedia component 308 and the processing component 302.

The memory 304 is configured to store various types of data so as to support operations on the device 300. Examples of these data include instructions of any application program or method used to be operated on the device 300, contact data, telephone directory data, messages, pictures, videos, and the like. The memory 304 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The electrical component 306 provides electric power for various components of the device 300. The electrical component 306 may include a power management system, one or more power sources, and other components associated with generating, managing and distributing electric power for the device 300.

The multimedia component 308 includes a screen providing an output interface between the device 300 and a user. In some embodiments, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some embodiments, the multimedia component 308 includes at least one of a front camera or a back camera. In response to determining that the device 300 is in an operation mode, such as a shooting mode or a video mode, at least one of the front camera or the back camera may receive external multimedia data. Each front camera and each back camera may be a fixed optical lens system or have a focal length and optical zooming capability.

The audio component 310 is configured to output and/or input an audio signal. For example, the audio component 310 includes a microphone (MIC). When the device 300 is in an operation mode, such as a call mode, a recording mode or a speech recognition mode, the microphone is configured to receive an external audio signal. The received audio signal may be further stored in the memory 304 or transmitted via the communication component 316. In some embodiments, the audio component 310 further includes a speaker for outputting the audio signal.

The I/O interface 312 provides an interface between the processing component 302 and a peripheral interface module, and the peripheral interface module may be a keyboard, a click wheel, buttons, etc. These buttons may include but are not limited to a home button, a volume button, a start button and a lock button.

The sensor component 314 includes one or more sensors for providing state evaluations of all aspects for the device 300. For example, the sensor component 314 may detect an on/off state of the device 300 and relative positioning of components, for example, the components are a display and a keypad of the device 300. The sensor component 314 may further detect location change of the device 300 or one component of the device 300, whether there is contact between the user and the device 300, azimuth or speed up/speed down of the device 300, and temperature change of the device 300. The sensor component 314 may include a proximity sensor, which is configured to detect existence of a nearby object without any physical contact. The sensor component 314 may further include an optical sensor, such as a CMOS or CCD image sensor, for use in an imaging application. In some embodiments, the sensor component 314 may further include an acceleration sensor, a gyroscope sensor, a magnetic sensor, a pressure sensor or a temperature sensor.

The communication component 316 is configured to facilitate wired or wireless communication between the device 300 and other devices. The device 300 may access a wireless network based on a communication standard, such as WiFi, 2G or 3G, or their combination. In an example, the communication component 316 receives a broadcast signal or broadcast related information from an external broadcast management system via a broadcast channel. In an example, the communication component 316 further includes a near-field communication (NFC) module so as to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In an example, the device 300 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the method.

In an example, a non-transitory computer readable storage medium including instructions is further provided, such as a memory 304 including instructions. The instructions may be executed by the processor 320 of the device 300 so as to complete the method. For example, the non-transitory computer readable storage medium may be an ROM, a random access memory (RAM), a CD-ROM, a magnetic tape, a floppy disk, an optical data storage device and the like.

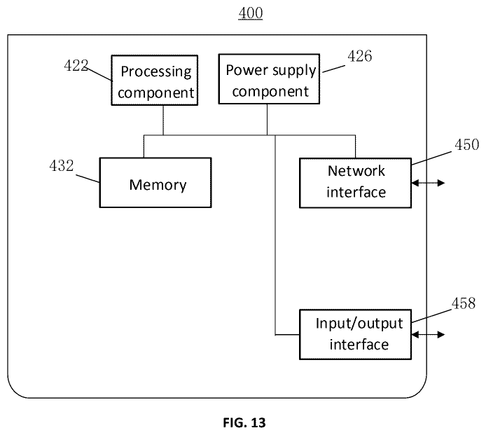

FIG. 13 is a block diagram of a device 400 for reporting power domain information according to an example. For example, the device 400 may be provided as a server. Referring to FIG. 13, the device 400 includes: a processing component 422, which further includes one or more processors; and a memory resource represented by a memory 432, for storing instructions executable by the processing component 422, such as an application program. The application program stored in the memory 432 may include one or more modules each of which corresponds to a set of instructions. In addition, the processing component 422 is configured to execute the instructions, so as to implement the method for reporting the power domain information.

The device 400 may further include: a power supply component 426 configured to perform power management of the device 400; a wired or wireless network interface 450 configured to connect the device 400 to a network; and an input/output (I/O) interface 458. The device 400 may operate based on an operating system stored in a memory 432, such as Windows Server™, Mac OS X™, Unix™, Linux™, FreeBSD™ or the like.

As used herein, the term “processor” may refer to one processor that performs the defined functions or a plurality of processors that collectively perform defined functions, such that the execution of the individual defined functions may be divided amongst such processors.

It may be further understood that in the present disclosure, “plurality of” refers to two or more than two, and other quantifiers are similar. “And/or” describes an association relationship of associated objects, and represents that there may be three kinds of relationships, for example, A and/or B, may represent: A exists alone, A and B exist at the same time, and B exists alone. A character “/” generally represents that the associated objects before and after the character are in an “or” relationship. The singular forms “a,” “the” and “this” are intended to include the plural forms as well, unless the context clearly indicates other meanings.

It may be further understood that the meanings of words such as “in response to,” “if” or “in case” mentioned in the present disclosure depend on the context and the actual usage scenario. For example, the word “in response to” used in the disclosure may be interpreted as “when” or “while” or “if”.

It may be further understood that the terms “first,” “second” and the like are used to describe various information, but these information needs not be limited to these terms. These terms are merely configured to distinguish the same type of information from one another, and do not imply a particular order or a level of importance. In fact, the expressions “first,” “second” and the like may be used completely interchangeably. For example, in a case of not departing from the scope of the present disclosure, first information may also be called second information, and similarly, the second information may also be called the first information.

It may be further understood that although in the embodiments of the present disclosure, the operations are described in a specific order in the accompanying drawings, it needs not be construed as requiring to perform the operations in the specific order shown or a serial order, or to perform all the operations shown to obtain desired results. In a certain circumstance, multitasking and parallel processing may be advantageous.

Those skilled in the art will easily figure out other implementation solutions of the present disclosure after considering the specification and practicing the invention disclosed here. The present application intends to cover any transformation, usage or adaptive change of the present disclosure, and these transformations, usages or adaptive changes conform to a general principle of the present disclosure and include common general knowledge or conventional technical means in the technical field not disclosed by the present disclosure.

It is to be understood that the present disclosure is not limited to the exact structure that has been described in the disclosure and shown in the accompanying drawings, and that various modifications and changes may be made without departing from the scope of the present disclosure. The scope of the present disclosure is limited merely by the scope of the appended claims.

1. A method for reporting power domain information, performed by a terminal, the method comprising:
measuring power domain information within an uplink evaluation period, wherein the power domain information at least comprises effective power information or effective energy information, and the effective power information or the effective energy information is configured to indicate power performance supported by the terminal within a remaining effective transmission time of the uplink evaluation period and predicted by the terminal; and
reporting the power domain information to a network device.

2. The method for reporting the power domain information according to claim 1, wherein the effective energy information comprises a remaining energy value of the terminal within the remaining effective transmission time of the uplink evaluation period, or a first mapping value corresponding to the remaining energy value.

3. The method for reporting the power domain information according to claim 1, wherein the effective power information comprises remaining power value information of the terminal within the remaining effective transmission time of the uplink evaluation period.

4. The method for reporting the power domain information according to claim 3, wherein the remaining power value information comprises at least one of the following:
a remaining power value;
power class information;
a second mapping value corresponding to the remaining power value; or
a differential power value between the remaining power value and a maximum transmit power reported in a power headroom report (PHR) reported last time;
wherein the second mapping value corresponding to the remaining power value is configured in at least one of the following:
configured based on a maximum power class (Pcmax) table; or
configured based on a pre-defined mapping table of an actual transmit power.

5. (canceled)

6. The method for reporting the power domain information according to claim 1,
wherein the effective power information comprises a number of symbols corresponding to a remaining energy value of the terminal within the remaining effective transmission time of the uplink evaluation period, or proportion information of the number of symbols in an entire time window of the uplink evaluation period.

7. The method for reporting the power domain information according to claim 6, wherein the proportion information comprises a proportion range occupied by the number of symbols in the entire time window of the uplink evaluation period; or
wherein the terminal stores a corresponding relationship between a proportion range and a third mapping value; and the proportion information comprises the third mapping value corresponding to the proportion range occupied by the number of symbols in the entire time window of the uplink evaluation period.

8. (canceled)

9. The method for reporting the power domain information according to claim 1, wherein the effective power information comprises transmission rate class information supported by the terminal within the remaining effective transmission time of the uplink evaluation period.

10. The method for reporting the power domain information according to claim 9, wherein the transmission rate class information comprises at least one of the following:
a service rate class;
a highest modulation and coding scheme (MCS) class; or
a maximum bandwidth class.

11. The method for reporting the power domain information according to claim 1, wherein in response to predicting occurrence of a transmission interruption of the terminal within the remaining effective transmission time of the uplink evaluation period, the effective power information or the effective energy information comprises an information value indicating the transmission interruption; or
wherein the effective power information or the effective energy information is included in at least one of the following: a power headroom report (PHR); a medium access control control element (MAC-CE); uplink control information (UCI); or radio resource control (RRC); or
wherein the power domain information within the uplink evaluation period is measured in at least one of the following: measuring power domain information of each carrier within the uplink evaluation period respectively; measuring power domain information of a specified carrier within the uplink evaluation period; or measuring power domain information of the terminal within the uplink evaluation period; or
wherein the power domain information is reported to the network device in at least one of the following: reporting power domain information of each carrier within the uplink evaluation period to the network device respectively; reporting power domain information of a specified carrier within the uplink evaluation period to the network device; or reporting power domain information of the terminal within the uplink evaluation period to the network device.

12-14. (canceled)

15. A method for receiving power domain information, performed by a network device, the method comprising:
receiving power domain information reported by a terminal,
wherein the power domain information at least comprises effective power information or effective energy information, and the effective power information or the effective energy information is configured to indicate power performance supported by the terminal within a remaining effective transmission time of an uplink evaluation period and predicted by the terminal.

16. The method for receiving the power domain information according to claim 15, wherein the effective energy information comprises a remaining energy value of the terminal within the remaining effective transmission time of the uplink evaluation period, or a first mapping value corresponding to the remaining energy value.

17. The method for receiving the power domain information according to claim 15, wherein the effective power information comprises remaining power value information of the terminal within the remaining effective transmission time of the uplink evaluation period.

18. The method for receiving the power domain information according to claim 17, wherein the remaining power value information comprises at least one of the following:
a remaining power value;
power class information;
a second mapping value corresponding to the remaining power value; or
a differential power value between the remaining power value and a maximum transmit power reported in a power headroom report (PHR) reported last time;
wherein the second mapping value corresponding to the remaining power value is configured in at least one of the following:
configured based on a maximum power class (Pcmax) table; or
configured based on a pre-defined mapping table of an actual transmit power.

19. (canceled)

20. The method for receiving the power domain information according to claim 15, wherein the effective power information comprises a number of symbols corresponding to a remaining energy value of the terminal within the remaining effective transmission time of the uplink evaluation period, or proportion information of the number of symbols in an entire time window of the uplink evaluation period.

21. The method for receiving the power domain information according to claim 20, wherein the proportion information comprises a proportion range occupied by the number of symbols in the entire time window of the uplink evaluation period; or
wherein the network device stores a corresponding relationship between a proportion range and a third mapping value; and the proportion information comprises the third mapping value corresponding to the proportion range occupied by the number of symbols in the entire time window of the uplink evaluation period.

22. (canceled)

23. The method for receiving the power domain information according to claim 15, wherein the effective power information comprises transmission rate class information supported by the terminal within the remaining effective transmission time of the uplink evaluation period.

24. The method for receiving the power domain information according to claim 23, wherein the transmission rate class information comprises at least one of the following:
a service rate class;
a highest modulation and coding scheme (MCS) class; or
a maximum bandwidth class.

25. The method for receiving the power domain information according to claim 15, wherein the effective power information or the effective energy information comprises an information value indicating transmission interruption; or
wherein the effective power information or the effective energy information is included in at least one of the following: a power headroom report (PHR); a medium access control control element (MAC-CE); uplink control information (UCI); or radio resource control (RRC); or
wherein the power domain information received by the network device comprises at least one of the following: power domain information, reported respectively by the terminal, of each carrier within the uplink evaluation period; power domain information, reported by the terminal, of a specified carrier within the uplink evaluation period; or power domain information, reported by the terminal, of the terminal within the uplink evaluation period.

26-29. (canceled)

30. A device for reporting power domain information, comprising:
one or more processors; and
a memory that stores processor-executable instructions;
wherein the processor-executable instructions, when collectively executed by the one or more processors, cause the device for reporting the power domain information to act as a terminal and to:
measure power domain information within an uplink evaluation period, wherein the power domain information at least comprises effective power information or effective energy information, and the effective power information or the effective energy information is configured to indicate power performance supported by the terminal within a remaining effective transmission time of the uplink evaluation period and predicted by the terminal; and
report the power domain information to a network device.

31. A device for receiving power domain information, comprising:
one or more processors; and
a memory that stores processor-executable instructions;
wherein the processor-executable instructions, when collectively executed by the one or more processors, cause the device for receiving the power domain information to act as the network device and to perform the method for receiving the power domain information according to claim 15.

32-33. (canceled)
